(19) United States
(12) Patent Application Publication
(10) Pub. No.: US 2008/0184332 A1
(43) Pub. Date: Jul. 31, 2008

(54) METHOD AND DEVICE FOR DUAL AUTHENTICATION OF A NETWORKING DEVICE AND A SUPPLICANT DEVICE

(75) Inventors: Anthony N. Gerkis, Ontario (CA); Krishna K. Bellamkonda, Arlington Heights, IL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/669,403

(22) Filed: Jan. 31, 2007

(51) Int. Cl. H04L 9/32; G06F 17/00; G06F 21/00

(52) U.S. Cl. 726/1; 726/10; 726/3

(57) ABSTRACT

A method for dual authentication of a networking device and a supplicant device presents an effective authentication strategy. The method includes establishing through a port of the networking device a link with the supplicant device. A communication link with a network is then established at the networking device. The supplicant device is then authenticated with the network through the communication link. Access to the port of the radio networking device is then controlled based on a status of the communication link with the network.

### FIELD OF THE INVENTION

The present invention relates generally to wireless communication devices, and in particular to secure authentication of devices in wireless networks.

### BACKGROUND

To ensure computer network security, subscribers to a computer network generally must be authenticated to the network before being granted network access. Various authentication procedures have therefore been developed to enable efficient, reliable and fast authentication.

The Extensible Authentication Protocol (EAP) was designed as an extension to a Point to Point Protocol (PPP) to enable various network access authentication processes. PPP requires that a specific authentication process be selected when establishing a link to a computer network. Using EAP, a specific authentication process is not selected when establishing a link to a network; rather, nodes in a network can determine to use a specific EAP authentication scheme during a connection authentication phase. This enables new EAP schemes to be introduced and used at any time.

The Institute of Electrical and Electronics Engineers (IEEE) 802.1X standard is based on EAP and is used for port-based Network Access Control (NAC). IEEE 802.1X is used to authenticate supplicant nodes and refuse network access at an Open Systems Interface (OSI) data link layer. When a supplicant node is detected by an IEEE 802.1X authenticator, a port at the authenticator is enabled, but is set to operate only in an “unauthorized” state. Such a state allows only IEEE 802.1X data to pass through the port. Other data such as Dynamic Host Configuration Protocol (DHCP) data or HyperText Transfer Protocol (HTTP) data are rejected at the data link layer. The authenticator then transmits an EAP-REQUEST (IDENTITY) message to the supplicant, and the supplicant replies with an EAP-RESPONSE packet that the authenticator forwards to an authenticating server. If the authenticating server approves the EAP-RESPONSE packet and grants the supplicant access to the network, the authenticator then changes the port to an “authorized” state, which allows normal data traffic to be transmitted between the supplicant and the network.

Authenticating a supplicant network user and the supplicant network user's transceiver device is generally completed as a single process, because the transceiver device generally functions as a network interface card. However, transceiver devices that serve more than one network user simultaneously, or that provide an application program interface for alternate means of data bearer access with interworking capabilities, elicit a need for authentication of both a supplicant network user and the supplicant network user's transceiver device.

### BRIEF DESCRIPTION OF THE DRAWINGS

In order that the invention may be readily understood and put into practical effect, reference will now be made to exemplary embodiments as illustrated with reference to the accompanying figures, wherein like reference numbers refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 is a message sequence chart (MSC) illustrating a method for dual authentication of a radio networking device and a supplicant device in an ad hoc network, according to some embodiments of the present invention.

FIG. 2 is a state diagram illustrating various states of a radio networking device, according to some embodiments of the present invention.

FIG. 3 is a general flow diagram illustrating a method for dual authentication of a radio networking device and a supplicant device, according to some embodiments of the present invention.

FIG. 4 is a general flow diagram illustrating a continuation of a method for dual authentication of a radio networking device and a supplicant device, according to some embodiments of the present invention.

FIG. 5 is a general flow diagram illustrating another continuation of a method for dual authentication of a radio networking device and a supplicant device, according to some embodiments of the present invention.

FIG. 6 is a block diagram illustrating components of a wireless communication device that can function as a radio networking device, according to some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to dual authentication of a radio networking device and a supplicant device. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of dual authentication of a radio networking device and a supplicant device as described herein. The non-processor circuits may include, but are not limited to, a radio receiver, a radio transmitter, signal drivers, clock circuits, power source circuits, and user input devices. As such, these functions may be interpreted as steps of a method for dual authentication of a radio networking device and a supplicant device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

According to one aspect, some embodiments of the present invention include a method for dual authentication of a radio networking device and a supplicant device that includes the following: establishing through a port of the radio networking device a link with the supplicant device; establishing at the radio networking device a radio frequency communication link with a network; authenticating the supplicant device with the network through the radio frequency communication link; and controlling access to the port of the radio networking device based on a status of the radio frequency communication link with the network. Thus some embodiments of the present invention enable a radio networking device to serve more than one network user simultaneously, and to provide an application programming interface for alternate means of data bearer access with interworking capabilities.

The Extensible Authentication Protocol (EAP) is now widely used in Wireless Fidelity (WiFi) (Institute of Electrical and Electronics Engineers (IEEE) 802.11) networks and in Worldwide Interoperability for Microwave Access (WiMax) (IEEE 802.16) networks. EAP is useful, for example, in ad hoc networks where a collection of nodes communicate by forming a multi-hop radio network without the need of infrastructure. Nodes in an ad hoc network forward information (e.g., frames) to other nodes by selecting one of various available routes to a destination node based on several parameters, such as link quality and round trip time. Generally ad hoc networks do not have a fixed topology. Nodes can dynamically join and leave an ad hoc network, and ad hoc networks can vary in degree of mobility. Further, an ad hoc network typically can heal itself by selecting alternate routes to a destination node when a first route is blocked, and thus each node in an ad hoc network can be viewed as a router. The above characteristics of ad hoc networks make ad hoc networks useful in various situations, such as public safety incident scenes, integrated command and control systems used in fire, police, rescue or other incident scene situations, vehicle area networks (VANs), and various mission critical local broadband (MCLB) situations, where infrastructure connectivity might not be available.

Device modems in many ad hoc networks provide an exposed Ethernet port for bridging to network infrastructure. As is known by those of ordinary skill in the art, such ports can be protected using IEEE 802.1X and EAP standards. However, in situations where transceiver devices serve more than one network user simultaneously, or where such devices provide an application program interface for alternate means of data bearer access with interworking capabilities, there is a need for separate authentication of both a radio networking device and a supplicant device.

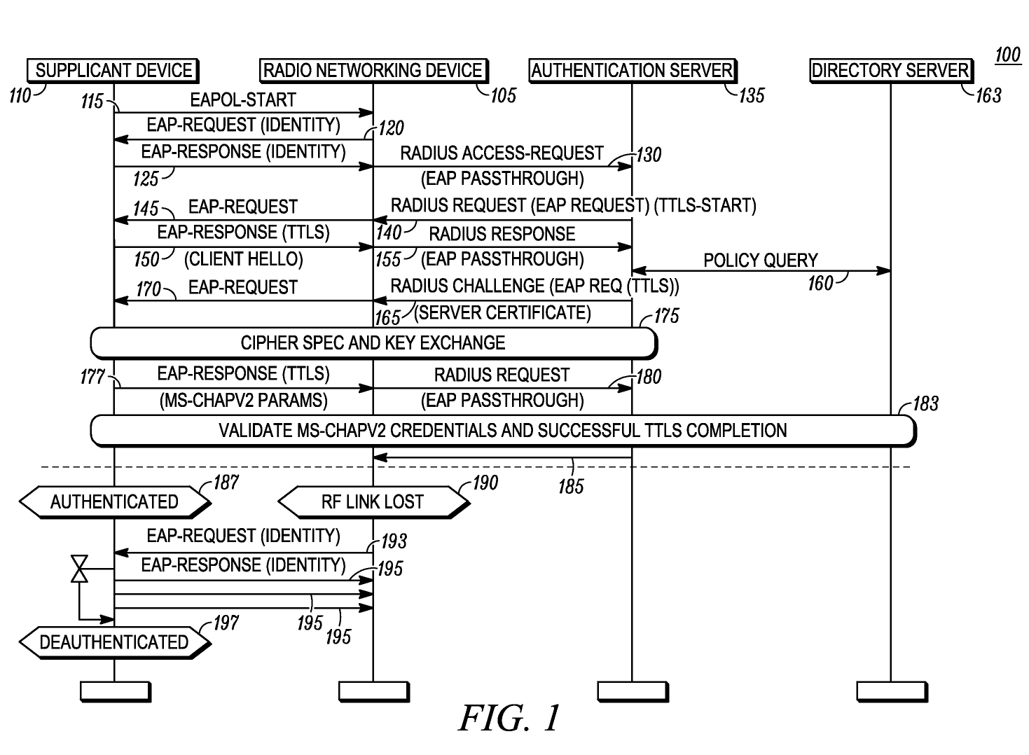

Referring to FIG. 1, a message sequence chart (MSC) illustrates a method for dual authentication of a radio networking device 105 and a supplicant device 110 in an ad hoc network 100, according to some embodiments of the present invention. For example, the radio networking device 105 can be a vehicle modem in a command vehicle operating in a vehicular area network (VAN), and the supplicant device 110 can be a notebook computer operating in the command vehicle, where the notebook computer is assigned to an individual user and is connected to the radio networking device 105 via an Ethernet cable. As will be understood by those skilled in the art, the ad hoc network 100 also may include various other nodes (not shown) in communication range of the radio networking device 105.

At line 115, an EAP over Local Area Network (EAPoL)-START message is transmitted from the supplicant device 110 to the radio networking device 105. At line 120, the radio networking device 105 acting as an authenticator responds by sending an EAP-REQUEST (IDENTITY) message back to the supplicant device 110. At line 125, the supplicant device 110 transmits an EAP-RESPONSE (IDENTITY) message to the radio networking device 105, which message is then passed through at line 130 as a Remote Authentication Dial-In User Service (RADIUS) ACCESS-REQUEST message to an authentication server 135. At line 140 the authentication server 135 then transmits a RADIUS REQUEST (EAP REQUEST) Tunneled Transport Layer Security (TTLS) START message to the radio networking device 105, which message is then forwarded at line 145 as an EAP-REQUEST message to the supplicant device 110. Next, at line 150 the supplicant device 110 responds with a client hello message in the form of an EAP-RESPONSE (TTLS) message 150 to the radio networking device 105, which at line 155 is passed through to the authentication server 135 as a RADIUS RESPONSE message.

If the authentication server 135 accepts the RADIUS RESPONSE message, then at line 160 a policy query is completed between the authentication server 135 and a directory server 163. During the policy query the directory server 163 can deliver to the authentication server 135 an authorization profile concerning the supplicant device 110. For example, the authorization profile can include level of service or class of service parameters and radio frequency (RF)-specific settings that the radio networking device 105 should employ for the supplicant device 110.

At line 165, the authentication server 135 transmits a server certificate in the form of a RADIUS CHALLENGE (EAP REQ (TTLS)) message to the radio networking device 105, which is then forwarded at line 170 as an EAP-REQUEST message to the supplicant device 110. At block 175, a cipher specification (cipherspec) and key exchange process is completed between the supplicant device 110, the radio networking device 105, and the authentication server 135. At line 177, mutual authentication parameters such as Microsoft Challenge Handshake Authentication Protocol Version 2 (MS-CHAPv2) parameters are transmitted as an EAP-RESPONSE (TTLS) message to the radio networking device 105, which at line 180 is passed through to the authentication server 135. At block 183, TTLS is completed between the supplicant device 110, the radio networking device 105, the authentication server 135, and the directory server 163, such as by validating MS-CHAPv2 credentials. At line 185, after successful completion of the authentication process, the authorization profile concerning the supplicant device 110 is delivered from the authentication server 135 to the radio networking device 105.

At block 187, a state of the supplicant device 110 is indicated as authenticated to the ad hoc network 100. However, at block 190, consider that a radio frequency (RF) link between the radio networking device 105 and the ad hoc network 100 is lost. Therefore, at line 193, the radio networking device 105 transmits an EAP-REQUEST (IDENTITY) message to the supplicant device 110. At lines 195, the supplicant device 110 then transmits a series of EAP-RESPONSE (IDENTITY) messages to the radio networking device 105, which messages are ignored by the radio networking device 105. At block 197, the supplicant device recognizes, because its EAP-RESPONSE (IDENTITY) messages have been ignored, that the radio networking device 105 has lost is RF link with the ad hoc network 100 and that the supplicant device 110 is therefore deauthenticated from the ad hoc network 100.

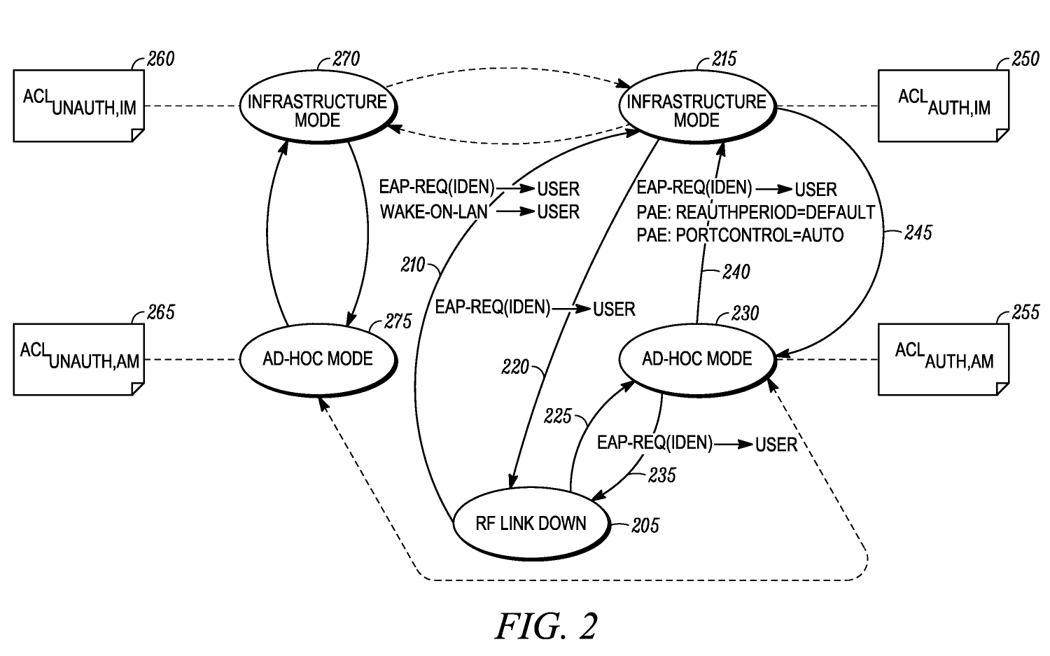

Referring to FIG. 2, a state diagram 200 illustrates various states of the radio networking device 105, according to some embodiments of the present invention. At a radio frequency (RF) link down state 205, the radio networking device 105 generally does not have connectivity to either infrastructure or a peer because a wireless network interface is inactive. A network port of the radio networking device 105 is therefore set to an unauthorized state. That prevents, for example, an attacker from gaining access to internal configuration details of a mobile transceiver via the network port.

Line 210 represents a transition from the RF link down state 205 to an infrastructure mode state 215. Such a transition can be similar to an initial authentication procedure, although a physical connection between the radio networking device 105 and the supplicant device 110, such as through an Ethernet cable, may have already been established and a wake-on local area network (LAN) procedure is used to initialize an authentication procedure. The infrastructure mode state 215 is a wireless connectivity state in which the radio networking device 105 is connected to a wide area network infrastructure. Generally, the wide area network infrastructure has connectivity to a data center and the radio networking device 105 forms part of a planned infrastructure. For example, such a planned infrastructure may have central authentication, policy and control elements, and be under a central administrative and security control of a network operator.

Line 220 represents a transition from the infrastructure mode state 215 to the RF link down state 205. Such a transition can occur for various reasons, such as the radio networking device 105 moving outside of a network coverage area, or temporary path loss due to RF fading or RF obstructions, such as can occur from buildings in urban canyons. Temporary path loss generally is registered as a transition to the RF link down state 205 only if relevant RF characteristics are present for a pre-defined period of time. After a transition at line 220, the RF link down state 205 is communicated to the supplicant device 110 to prevent packet losses and to indicate a lack of network connectivity to network enabled applications such as web browsers and video streaming applications. Such communication can be made for example by a lack of response from the radio networking device 105 to EAP-RESPONSE (IDENTITY) messages received from the supplicant device 110, such as illustrated by lines 195 in FIG. 1.

Line 225 represents a transition from the RF link down state 205 to an ad hoc mode state 230, where the radio networking device 105 communicates with peer client endpoints without using a planned infrastructure. For example, such a transition can be effected by the method for dual authentication between the supplicant device 110 and the radio networking device 105, as illustrated in FIG. 1, based on policies that are provided in the authorization profile sent to the radio networking device 105 at line 185.

Line 235 represents a transition from the ad hoc mode state 230 to the RF link down state 205. For example, such a transition can be caused by an absence of RF connectivity with infrastructure, or an absence of ad hoc peers in a neighborhood of the radio networking device 105. Here again the RF link down state 205 can be communicated to the supplicant device 110 by a lack of response from the radio networking device 105 to EAP-RESPONSE (IDENTITY) messages received from the supplicant device 110, such as illustrated by lines 195 in FIG. 1.

Line 240 represents a transition from the ad hoc mode state 230 to the infrastructure mode state 215. For example, such a transition can be caused by an ad hoc networking peer leaving a neighborhood of the radio networking device 105, or by detection of infrastructure by the radio networking device 105. An EAP REQUEST (IDENTITY) message is then transmitted from the radio networking device 105 to the infrastructure to initiate authentication of the supplicant device 110. The supplicant device 110, as a port access entity (PAE) of the radio networking device 105, then has a reauthentication period (reAuthPeriod) field set to a default value and a port control (portControl) field set to an automatic value.

Line 245 represents a transition from the infrastructure mode 215 to the ad hoc mode 230. For example, such a transition can be caused by an ad hoc networking peer leaving a neighborhood of the radio networking device 105, or by a loss at the radio networking device 105 of a signal from infrastructure.

According to some embodiments of the present invention, access control concerning the supplicant device 110 is effected at the radio networking device 105 based both on a status of the radio networking device 105 and on a status of the supplicant device 110. For example, four different access control lists (ACLs) 250, 255, 260, 265 can be used to manage the various operating permutations involving the radio networking device 105 in the infrastructure mode state 215 and the ad hoc mode state 230, and the supplicant device 110 in an IEEE 802.1X unauthorized state and an IEEE 802.1X authorized state. The ACL 250 is used when the supplicant device 110 is operating in an IEEE 802.1X authorized state and the radio networking device 105 is operating in the infrastructure mode state 215; the ACL 255 is used when the supplicant device 110 is operating in an IEEE 802.1X authorized state and the radio networking device 105 is operating in the ad hoc mode state 230; the ACL 260 is used when the supplicant device 110 is operating in an IEEE 802.1X unauthorized state and the radio networking device 105 is operating in an infrastructure mode state 270; and the ACL 265 is used when the supplicant device 110 is operating in an IEEE 802.1X unauthorized state and the radio networking device 105 is operating in an ad hoc mode state 275. The infrastructure mode states 215, 270 are thus identical except that they concern different IEEE 802.1X states of the supplicant device 110. Similarly, the ad hoc mode states 230, 275 are identical except that they concern different IEEE 802.1X states of the supplicant device 110.

The ACLs 250, 255, 260, 265 enable significant flexibility for controlling a network port of the radio networking device 105. For example, when an authentication status of the supplicant device 110 is an unauthorized status, the access control lists 260, 265 enable a network port of the radio networking device 105 to be used by the supplicant device 110 to bootstrap a connection to a network. Thus the ACLs 260, 265 may enable hypertext transfer protocol (HTTP) traffic, or virtual private network (VPN) traffic, to pass through the network port of the radio networking device 105 to a destination gateway, but all other traffic through the port will be blocked.

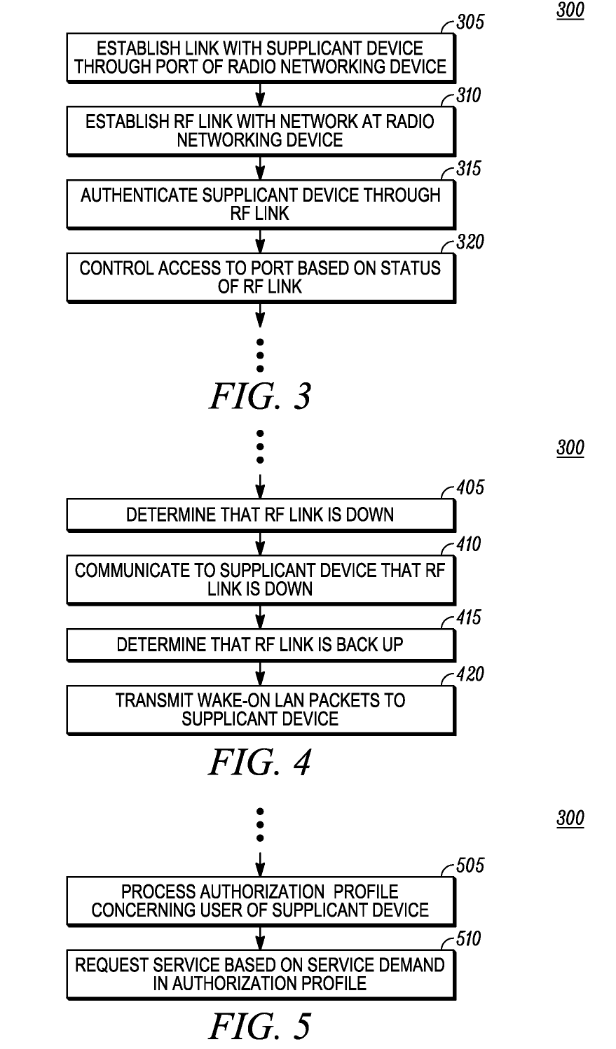

Referring to FIG. 3, a general flow diagram illustrates a method 300 for dual authentication of a radio networking device and a supplicant device, according to some embodiments of the present invention. At Step 305, a link with the supplicant device is established through a port of the radio networking device. For example, an Ethernet cable can be connected between the radio networking device 105 and the supplicant device 110.

Next, at Step 310, a communication link, such as a radio frequency link, with a network is established at the networking device. For example, the radio networking device 105 establishes an RF link with a peer in the ad hoc mode state 275, or an RF link with infrastructure in the infrastructure mode state 270.

Next, at Step 315, the supplicant device is authenticated with the network through the radio frequency link. For example, the supplicant device 110 is authenticated with the ad hoc network 100 using the messages illustrated in FIG. 1.

Next, at Step 320, access to the port of the radio networking device is controlled based on a status of the radio frequency link with the network. For example, access to a network port of the radio networking device 105 is controlled using the ACL 250 or the ACL 260 when the radio networking device 105 is in the infrastructure mode state 215, and is controlled using the ACL 255 or the ACL 265 when the radio networking device 105 is in the ad hoc mode state 230. Thus the method 300 can comprise executing a first port authentication policy when the radio networking device operates in an infrastructure mode, and executing a second port authentication policy when the radio networking device operates in an ad hoc mode.

Next, at Step 325, access to the port of the radio networking device is controlled based on an authentication status of the supplicant device. For example, access to a network port of the radio networking device 105 is controlled using the ACL 250 or the ACL 255 when the supplicant device 110 is in an IEEE 802.1X authorized state, and is controlled using the ACL 260 or the ACL 265 when the supplicant device 110 is in an IEEE 802.1X unauthorized state. Thus the method 300 can comprise controlling access to the port using a first access control list when an authentication status of the supplicant device is an unauthorized status, and using a second access control list when an authentication status of the supplicant device is an authorized status.

Referring to FIG. 4, a general flow diagram illustrates a continuation of the method 300 for dual authentication of a radio networking device and a supplicant device, according to some embodiments of the present invention. At Step 405, it is determined that the communication link with the network is down. For example, the radio networking device 105 determines that it has lost an RF link with the ad hoc network 100, and therefore the radio networking device 105 transitions from the ad hoc mode state 230 to the RF link down state 205.

Next, at Step 410, it is communicated to the supplicant device that the radio frequency link with the network is down by not responding to an EAP-RESPONSE (IDENTITY) message received from the supplicant device at the networking device. For example, the radio networking device 105 ignores the EAP-RESPONSE (IDENTITY) messages sent at the lines 195 from the supplicant device 110.

Next, at Step 415, after determining that the radio frequency link with the network is down, it is determined that the radio frequency link with the network is back up. For example, after transitioning from the ad hoc mode state 230 to the RF link down state 205, the radio networking device 105 determines that it is able to connect to infrastructure.

Next, at Step 420, wake-on LAN packets are transmitted from the radio networking device to the supplicant device to initiate an authentication process at the supplicant device. For example, at line 210, the radio networking device 105 transmits wake-on LAN packets to the supplicant device 110 during a transition from the RF link state down state 205 to the infrastructure mode state 215.

Referring to FIG. 5, a general flow diagram illustrates another continuation of the method 300 for dual authentication of a radio networking device and a supplicant device, according to some embodiments of the present invention. At Step 505, an authorization profile concerning a user of the supplicant device is processed. For example, the authorization profile, received at line 185 from the authentication server 135, is processed at the radio networking device 105 after authenticating the supplicant device 110 with the ad hoc network 100.

Next, at Step 510, service from the network is requested, as a proxy for a user of the supplicant device, based on a service demand included in the authorization profile. For example, a user of the supplicant device 110 can demand a particular quality of service (QoS) or class of service, such as voice service, video service, or best efforts service, on an air interface, such as a WiMAX or IEEE 802.11i air interface, between the radio networking device 105 and another node in the ad hoc network 100.

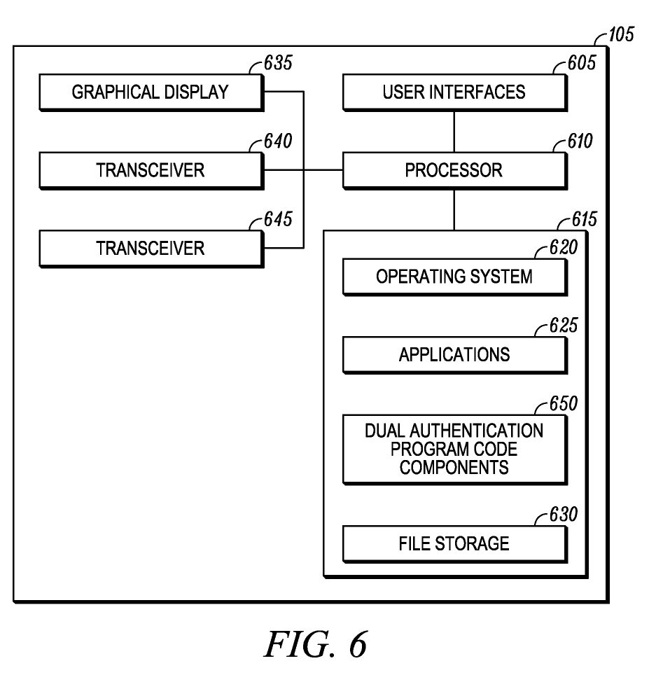

Referring to FIG. 6, a block diagram illustrates components of a wireless communication device that can function as the radio networking device 105, according to some embodiments of the present invention. The radio networking device 105 can be, for example, a WiMAX vehicle modem, an IEEE 802.11i modem, or a mesh network vehicular modem, and can operate in various circumstances, such as part of a vehicular modem system in a command vehicle in a vehicular area network (VAN). The radio networking device 105 comprises user interfaces 605 operatively coupled to at least one processor 610. At least one memory 615 is also operatively coupled to the processor 610. The memory 615 has storage sufficient for an operating system 620, applications 625 and general file storage 630. The general file storage 630 can store, for example, application profiles received from an authentication server concerning a particular user of a supplicant device or port access entity (PAE). The user interfaces 605 can be a combination of user interfaces including, for example, but not limited to a keypad, a touch screen, a microphone and a communications speaker. A graphical display 635, which can also have a dedicated processor and/or memory, drivers, etc., is operatively coupled to the processor 610. A number of transceivers, such as a first transceiver 640 and a second transceiver 645, are also operatively coupled to the processor 610. The first transceiver 640 and the second transceiver 645 communicate with various wireless communications networks, such as the ad hoc network 100, using various standards such as, but not limited to, Evolved Universal Mobile Telecommunications Service Terrestrial Radio Access (E-UTRA), Universal Mobile Telecommunications System (UMTS), Enhanced UMTS (E-UMTS), Enhanced High Rate Packet Data (E-HRPD), Code Division Multiple Access 2000 (CDMA2000), Institute of Electrical and Electronics Engineers (IEEE) 802.11, IEEE 802.16, and other standards.

It is to be understood that FIG. 6 is for illustrative purposes only and includes only some components of the radio networking device 105, in accordance with some embodiments of the present invention, and is not intended to be a complete schematic diagram of the various components and connections between components required for all devices that may implement various embodiments of the present invention.

The memory 615 comprises a computer readable medium that records the operating system 620, the applications 625, and the general file storage 630. The computer readable medium also comprises computer readable program code components 650 concerning dual authentication of a radio networking device and a supplicant device. When the computer readable program code components 650 are processed by the processor 610, they are configured to cause the execution of the method 300 for transmitting a data packet, as described above, according to some embodiments of the present invention.

Advantages of some embodiments of the present invention therefore include enabling a radio networking device to serve more than one network user simultaneously, and to provide an application programming interface for alternate means of data bearer access with interworking capabilities. EAPOL-REQUEST (IDENTITY) messaging can be tied to a radio networking device radio interface link status to provide a transparent and configurable mechanism for moving a supplicant device to a disconnected state without requiring special supplicant software. Also, an authenticator state of the radio networking device can be a function of a mesh operation mode (such as an ad hoc mode) of the device. Further, according to some embodiments of the present invention, RADIUS attributes can be communicated to a radio networking device in the form of an authorization profile that describes, for example, information on data flow and QoS parameters for a particular supplicant device. Transfer of such an authorization profile can be transparent to the supplicant device. These advantages can be useful in various products and circumstances, including integrated command and control systems used in fire, police, rescue or other incident scene situations, and in various mission critical local broadband (MCLB) solutions that can provide only limited infrastructure mode communications. Other applications of embodiments of the present invention include, for example, telematics in vehicle area networks (VANs), such as where vehicles cycle frequently between vehicle-to-vehicle ad hoc mode communications and infrastructure mode communications.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any elements that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims.

We claim:

1. A method for dual authentication of a networking device and a supplicant device, the method comprising:
establishing through a port of the networking device a link with the supplicant device;
establishing at the networking device a communication link with a network;
authenticating the supplicant device with the network through the communication link; and
controlling access to the port of the networking device based on a status of the communication link with the network.

2. The method of claim 1, wherein controlling access to the port of the networking device based on a status of the communication link with the network comprises executing a first port authentication policy when the networking device operates in an infrastructure mode, and executing a second port authentication policy when the networking device operates in an ad hoc mode.

3. The method of claim 1, further comprising:
controlling access to the port of the networking device based on an authentication status of the supplicant device.

4. The method of claim 3, wherein the networking device controls access to the port using a first access control list when an authentication status of the supplicant device is an unauthorized status, and using a second access control list when an authentication status of the supplicant device is an authorized status.

5. The method of claim 3, wherein the authentication status of the supplicant device is based on an Institute of Electrical and Electronics Engineers 802.1X state.

6. The method of claim 1, further comprising:
determining that the communication link with the network is down; and
communicating to the supplicant device that the communication link with the network is down by not responding to an EAP-RESPONSE (IDENTITY) message received from the supplicant device at the networking device.

7. The method of claim 1, further comprising:
after determining that the communication link with the network is down, determining that the communication link with the network is back up; and
transmitting wake-on Local Area Network (LAN) packets from the networking device to the supplicant device to initiate an authentication process at the supplicant device.

8. The method of claim 4, wherein, when an authentication status of the supplicant device is an unauthorized status, the first access control list enables the port to be used by the supplicant device to bootstrap a connection to the network.

9. The method of claim 1, wherein the networking device is a WiMAX vehicle modem, an IEEE 802.11i modem, or a mesh network vehicular modem.

10. The method of claim 1, further comprising:
processing an authorization profile concerning a user of the supplicant device; and
requesting, as a proxy for a user of the supplicant device, services from the network based on services demands included in the authorization profile.

11. The method of claim 10, wherein the authorization profile is received from an authentication server after authenticating the supplicant device with the network.

12. A networking device, comprising:
computer readable program code components configured to cause establishing through a port of the networking device a link with the supplicant device;
computer readable program code components configured to cause establishing at the networking device a communication link with a network;
computer readable program code components configured to cause authenticating the supplicant device with the network through the communication link; and
computer readable program code components configured to cause controlling access to the port of the networking device based on a status of the communication link with the network.

13. The device of claim 12, wherein controlling access to the port of the networking device based on a status of the communication link with the network comprises executing a first port authentication policy when the networking device operates in an infrastructure mode, and executing a second port authentication policy when the networking device operates in an ad hoc mode.

14. The device of claim 12, further comprising:
computer readable program code components configured to cause controlling access to the port of the networking device based on an authentication status of the supplicant device.

15. The device of claim 12, wherein the authentication status of the supplicant device is based on an Institute of Electrical and Electronics Engineers 802.1X state.

16. The device of claim 12, further comprising:
computer readable program code components configured to cause determining that the communication link with the network is down; and
computer readable program code components configured to cause communicating to the supplicant device that the communication link with the network is down by not responding to an EAP-RESPONSE (IDENTITY) message received from the supplicant device at the networking device.

17. The device of claim 16, further comprising:
computer readable program code components configured to cause after determining that the communication link with the network is down, determining that the communication link with the network is back up; and
computer readable program code components configured to cause transmitting wake-on Local Area Network (LAN) packets from the networking device to the supplicant device to initiate an authentication process at the supplicant device.

18. The device of claim 12, wherein, when an authentication status of the supplicant device is an unauthorized status, a first access control list enables the port to be used by the supplicant device to bootstrap a connection to the network.

19. The device of claim 12, wherein the networking device is a WiMAX vehicle modem, an IEEE 802.11i modem, or a mesh network vehicular modem.

20. The device of claim 12, further comprising:
computer readable program code components configured to cause processing an authorization profile concerning a user of the supplicant device; and
computer readable program code components configured to cause requesting, as a proxy for a user of the supplicant device, services from the network based on services demands included in the authorization profile.
